(19) United States
(12) Patent Application Publication
(10) Pub. No.: US 2021/0200277 A1
(43) Pub. Date: Jul. 1, 2021

(54) HINGE STRUCTURE FOR TERMINAL FOLDABLE IN BOTH DIRECTIONS

(71) Applicant: AUFLEX CO., LTD., Hwaseong-si (KR)

(72) Inventors: Hyun Min PARK, Suwon-si (KR); Seoung Jun LEE, Uiwang-si (KR)

(21) Appl. No.: 17/056,787

(22) PCT Filed: May 20, 2019
(86) PCT No.: PCT/KR2019/006034

§ 371 Date: Nov. 19, 2020

(30) Foreign Application Priority Data
May 20, 2018 (KR) 10-2018-0057530

(51) Int. Cl. G06F 1/16; E05D 3/12

(52) U.S. Cl. CPC G06F 1/1681; E05D 3/122; E05Y 2201/71; E05Y 2201/708; E05Y 2900/606

(57) ABSTRACT

A hinge structure for a mobile communication terminal that is foldable in both directions is provided. The hinge structure for a mobile communication terminal having a flexible display panel installed therein is foldable in two opposite directions is foldable inward and outward in a fully unfolded state and a screen on which an image such as a moving image is displayed is invisibly disposed inside or visibly disposed outside in a state in which the mobile communication terminal is folded.

### TECHNICAL FIELD

The invention relates to a hinge structure for a mobile communication terminal that is foldable in both directions and, more particularly, to a hinge structure for a mobile communication terminal that is foldable in both directions in which the hinge structure for a mobile communication terminal having a flexible display panel installed therein is foldable inward and outward in a fully unfolded state and a screen on which an image such as a moving image is displayed is invisibly disposed inside or visibly disposed outside in a state in which the mobile communication terminal is folded.

### BACKGROUND ART

Mobile communication terminals are configured to perform various functions. Examples of the functions include a data and speech communication function, a function of capturing a still image or a moving image using a camera, a speech storing function, a function of reproducing a music file using a speaker system, and a function of displaying a still image or a moving image (a video).

Some mobile communication terminals have additional functions for playing games, and some mobile communication terminals are embodied as multimedia devices. Recent mobile communication terminals can also receive broadcast or multicast signals and reproduce a video or a television program.

Researches for supporting and improving other functions of mobile communication terminals in addition to the above-mentioned functions have been carried out. These researches include modification and improvement of structural constituents of the mobile communication terminals and addition and improvement of software or hardware.

In general, a display module of a mobile communication terminal displays information which is processed by the mobile communication terminal. For example, when the mobile communication terminal is in a call mode, the display module displays a user interface (UI) or a graphic user interface (GUI) associated with a call.

When the mobile communication terminal is in a video call mode or an image capturing mode, the display module displays a captured or/and received image, a UI, or a GUI. The display module includes a liquid crystal display, a thin-film transistor liquid crystal display, an organic light emitting diode, a flexible display, or a 3D display.

A flexible display (or a flexible LCD) has been regularly researched with its merit of deformability. It takes much time to use a rolled display like a paper roll as shown in science-fiction movie.

Therefore, transitional forms of flexible displays will be many used until the flexible displays are regularly used with sufficient development thereof, and these transitional forms will be similar to current structures of communication terminals. Accordingly, there is necessity for description of usage and protection of flexible displays when such flexible displays are used in mobile communication terminals.

An example of such a hinge structure for a mobile communication terminal having a flexible display panel installed therein is disclosed in Korean Patent Application Laid-open No. 10-2015-0096827 (Title of the Invention: HINGE STRUCTURE AND FOLDABLE DISPLAY DEVICE INCLUDING THE SAME).

### SUMMARY OF THE INVENTION

### Technical Problem

An objective of the invention is to provide a hinge structure for a mobile communication terminal that is foldable in two opposite directions in which the hinge structure for the mobile communication terminal having a flexible display panel installed therein is foldable inward and outward in a fully unfolded state and a screen on which an image such as a moving image is displayed is invisibly disposed inside or visibly disposed outside in a state in which the mobile communication terminal is folded.

### Solution to Problem

In order to achieve the above-mentioned objective, there is provided a hinge structure for a mobile communication terminal that is foldable in two opposite directions.

The hinge structure for a mobile communication terminal that is foldable in two opposite directions employs the following configurations.

The hinge structure includes: upper panels 10 and lower panels 30 that are provided on right and left sides of a central joint 40 and that are foldable inward and outward with respect to the central joint 40; upper joints 41 and 42 that are provided on the right and left sides of a top of the central joint 40 and that are connected to the upper panels 10 and connected to each other; and lower joints 34 that are provided on the right and left sides of a bottom of the central joint 40 and that are connected to lower sliders 32.

The hinge structure for a mobile communication terminal that is foldable in two opposite directions may further include upper hinge portions and lower hinge portions that are connected to each other with the central joint 40 interposed therebetween.

The upper hinge portions may be connected to the two upper joints 41 and 42 via which the right and left upper panels (10) are rotatably connected to the top of the central joint 40.

The lower hinge portions may be connected to the two lower joints 34 via which the right and left lower sliders 32 are rotatably connected to the bottom of the central joint 40.

The right and left lower sliders 32 may be inserted into the right and left lower panels 30 and the right and left panels (30) may be coupled to the right and left upper panels 10.

Tilt grooves 13 may be formed in end faces of right and left upper sliders 12 connected to the central joint (40).

The tilt grooves 13 formed on the end face of each upper slider 12 may be connected to an elastically driven member 48 such that an elastic force is applied to the tilt grooves from the elastically driven member 48.

A protruding tip portion of the elastically driven member 48 may be hooked to the tilt grooves 13.

The central joint 40 may include a four-axis gear in which a pair of rotational bars 44 and two gears 45 engaging with the rotational bars 44 are coupled to each other.

The pair of rotational bars 44 engaging with each other may be configured to rotate simultaneously in opposite directions.

A support portion 141 of each first upper joint 41 may be provided to come into contact with a surface of the central joint 40 in a state in which the upper panels 10 and the lower panels 30 coupled to the upper panels 10 are fully unfolded.

### Advantageous Effects of the Invention

With the hinge structure for a mobile communication terminal that is foldable in two opposite directions according to the invention, the hinge structure for a mobile communication terminal having a flexible display panel installed therein is configured to be foldable inward and outward in a fully unfolded state and a screen on which an image such as a moving image is displayed is invisibly located inside or visibly located outside in a state in which the mobile communication terminal is folded.

According to the invention, the support portion of the first upper joint is provided to come into contact with the surface of the central joint in a state in which the upper panels and the lower panels coupled to the upper panels are fully unfolded. A part of the flexible display panel attached onto the first upper joint is prevented from being recessed inward when it is pressed by a user. Accordingly, it is possible to prevent the part of the flexible display panel from being damaged.

### REFERENCE SIGNS LIST

10: Upper panel, 12: upper slider, 15: Guide rail

30: Lower panel, 32: Upper slider, 36: Guide rail

40: Central joint, 41: First upper joint, 44: Rotational bar

48: Elastically driven member, 50: Cover, 141: Support portion

### BRIEF DESCRIPTION OF THE DRAWINGS

FIG. 1 is a perspective view of a hinge structure for a mobile communication terminal that is foldable in two opposite directions according to the invention.

FIG. 2 is an enlarged perspective view of Part A illustrated in FIG. 1.

FIG. 3 is a perspective view illustrating a state in which an upper hinge portion and a lower hinge portion connected to a central joint are separated from each other in the hinge structure for a mobile communication terminal that is foldable in two opposite directions according to the invention.

FIG. 4 is an exploded perspective view illustrating the upper hinge portion and the lower hinge portion illustrated in FIG. 3.

FIG. 5 is an exploded perspective view of the upper hinge portion in the hinge structure for a mobile communication terminal that is foldable in two opposite directions according to the invention.

FIG. 6 is an exploded perspective view of a central joint and upper joints and upper sliders which are connected to the top of the central joint in the hinge structure for a mobile communication terminal that is foldable in two opposite directions according to the invention.

FIG. 7 is a perspective view illustrating a state in which the upper joints and the upper sliders are coupled to the central joint in the upper hinge portion of the hinge structure for a mobile communication terminal that is foldable in two opposite directions according to the invention.

FIG. 8 is an exploded perspective view illustrating a state in which the upper sliders are coupled to the central joint according to the invention.

FIG. 9 is an exploded perspective view of the central joint and lower joints and lower sliders which are connected to the bottom of the central joint in the hinge structure for a mobile communication terminal that is foldable in two opposite directions according to the invention.

FIG. 10 is an exploded perspective view of the central joint according to the invention.

FIG. 11 is a perspective view of the assembled central joint according to the invention.

FIG. 12 is a perspective view illustrating the inside of the upper hinge portion of the hinge structure for a mobile communication terminal that is foldable in two opposite directions according to the invention.

FIG. 13 is a perspective view illustrating a state in which the upper hinge portion illustrated in FIG. 12 is partially folded.

FIG. 14 is a perspective view illustrating a state in which a first upper joint connected to the top of the central joint according to the invention is cut.

FIG. 15 is a sectional view illustrating movement of rotational bars and gears on the right and left sides of the central joint while the hinge structure for a mobile communication terminal that is foldable in two opposite directions according to the invention is being unfolded in a folded state in an in-folding manner.

FIG. 16 is a sectional view illustrating movement of rotational bars and gears on the right and left sides of the central joint while the hinge structure for a mobile communication terminal that is foldable in two opposite directions according to the invention is being folded in a folded state in an out-folding manner.

FIG. 17 is a sectional view illustrating a state in which support portions of the first upper joints and the top surface of the central joint come into contact with each other while the hinge structure for a mobile communication terminal that is foldable in two opposite directions according to the invention is unfolding in the folded state in the in-folding manner and being folded in the out-folding manner.

FIG. 18 is a sectional view illustrating movement of internal elements while the hinge structure for a mobile communication terminal that is foldable in two opposite directions according to the invention is being unfolded in the folded state in the in-folding manner in a state in which a flexible display panel is installed on the upper panels of the hinge structure.

FIG. 19 is a sectional view illustrating arrangement of the elements in a state in which the hinge structure for a mobile communication terminal that is foldable in two opposite directions according to the invention is fully unfolded in the state in which a flexible display panel is installed on the upper panels of the hinge structure.

FIG. 20 is a sectional view illustrating movement of internal elements while the hinge structure for a mobile communication terminal that is foldable in two opposite directions according to the invention is being folded in the out-folding manner.

FIG. 21 is a perspective view of a joint structure in which movement of two joints on the right and left sides of the central joint is limited.

FIG. 22 is an exploded perspective view of the joint structure illustrated in FIG. 21.

FIG. 23 is a perspective view of the joint structure illustrated in FIG. 21 from the bottom side.

FIG. 24 is an end view of the joint structure when it is folded in two opposite directions about the central joint.

### EMBODIMENTS OF THE INVENTION

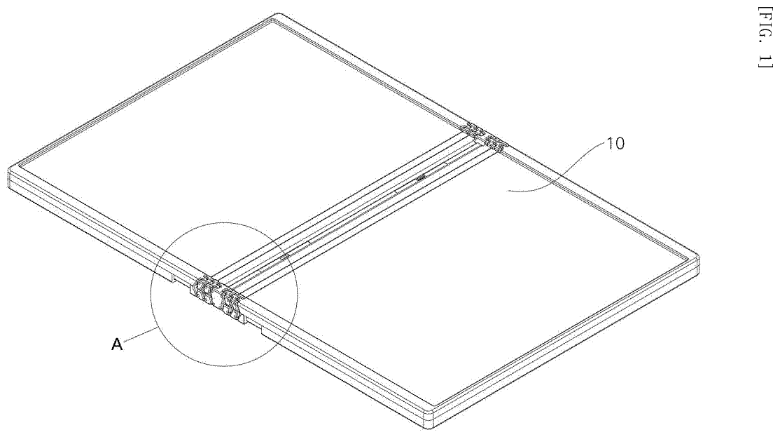

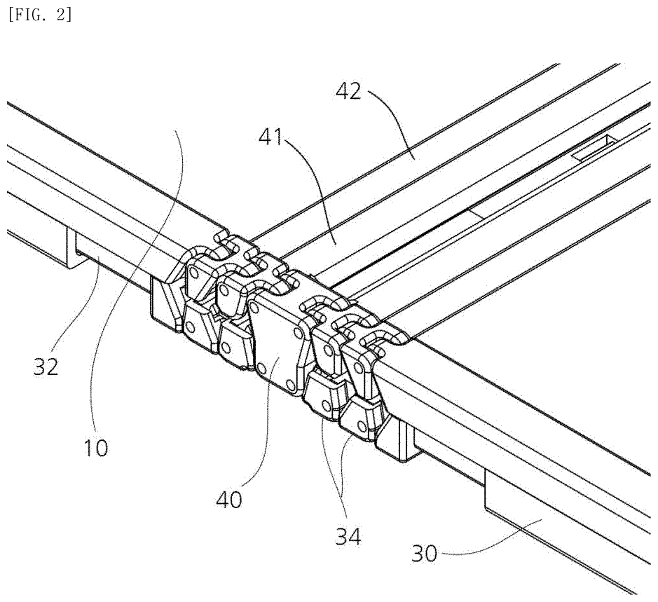

FIG. 1 is a perspective view of a hinge structure for a mobile communication terminal that is foldable in two opposite directions according to the invention. FIG. 2 is an enlarged perspective view of Part A illustrated in FIG. 1.

Referring to FIGS. 1 and 2, a hinge structure for a mobile communication terminal that is foldable in two opposite directions according to the invention has a configuration in which upper panels 10 and lower panels 30 on the right and left sides of a central joint 40 are foldable inward and foldable outward.

Upper joints 41 and 42 connected to the upper panels 10 are connected to the right and left sides of the top of the central joint 40. Lower joints 34 connected to lower sliders 32 are connected to the right and left sides of the bottom of the central joint 40.

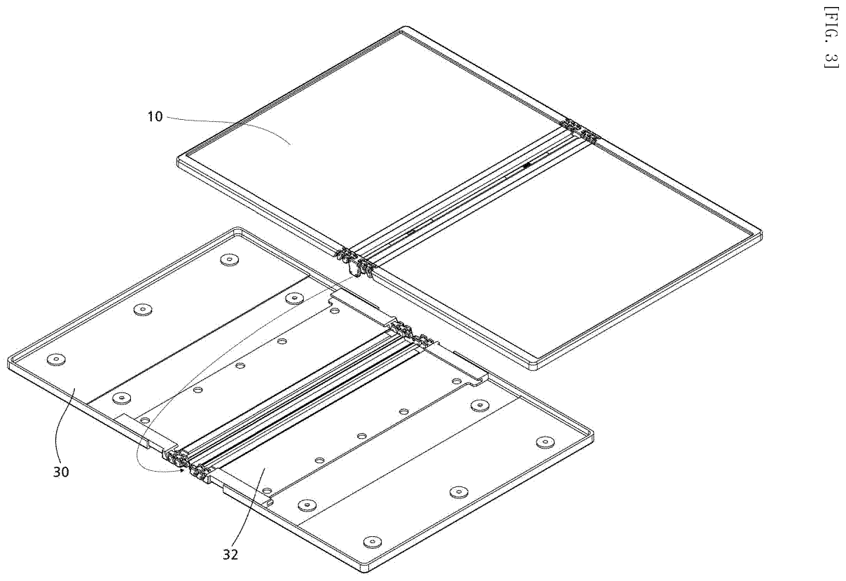

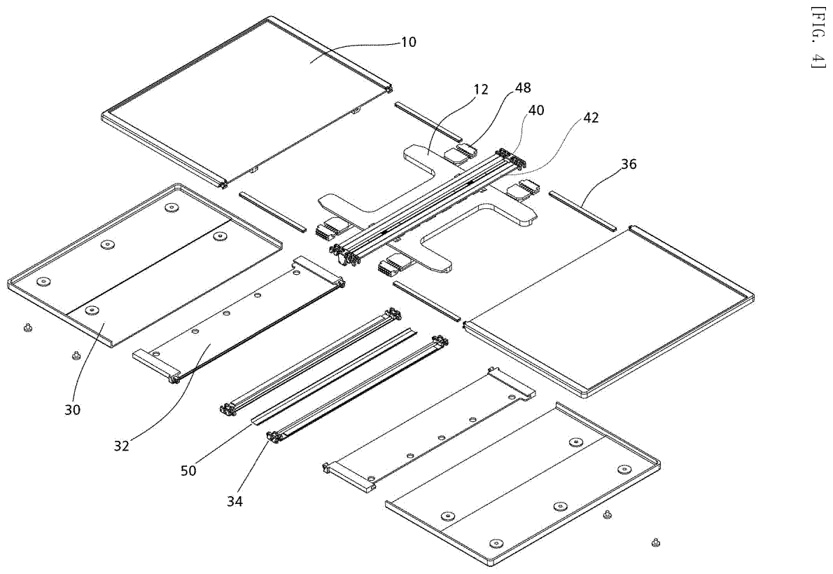

FIG. 3 is a perspective view illustrating a state in which an upper hinge portion and a lower hinge portion connected to a central joint are separated from each other in the hinge structure for a mobile communication terminal that is foldable in two opposite directions according to the invention. FIG. 4 is an exploded perspective view illustrating the upper hinge portion and the lower hinge portion illustrated in FIG. 3.

Referring to FIGS. 3 and 4, the hinge structure for a mobile communication terminal that is foldable in two opposite directions according to the invention has a configuration in which an upper hinge portion and a lower hinge portion are connected to each other with the central joint 40 interposed therebetween.

According to the invention, the upper hinge portion includes first and second upper joints 41 and 42 via which the right and left upper panels 10 are rotatably connected to the top of the central joint 40.

According to the invention, the lower hinge portion includes two lower joints 34 via which the right and left lower sliders 32 are rotatably connected to the bottom of the central joint 40.

The lower sliders 32 are inserted into the right and left lower panels 30 according to the invention. The right and left lower panels 30 are coupled to the right and left upper panels 10.

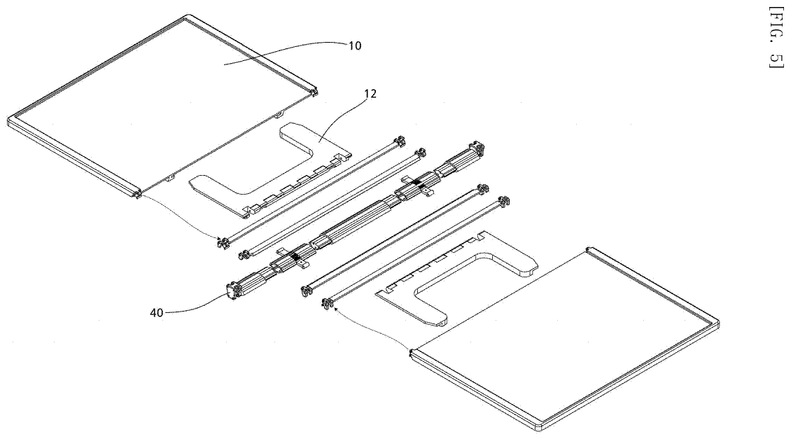

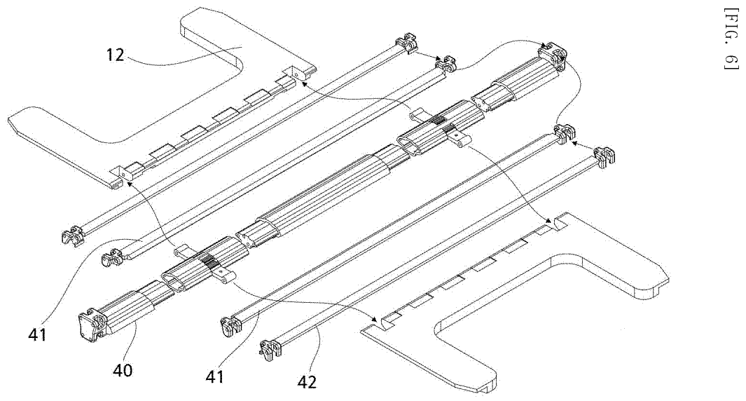

FIG. 5 is an exploded perspective view of the upper hinge portion in the hinge structure for a mobile communication terminal that is foldable in two opposite directions according to the invention. FIG. 6 is an exploded perspective view of a central joint and upper joints and upper sliders which are connected to the top of the central joint in the hinge structure for a mobile communication terminal that is foldable in two opposite directions according to the invention.

Referring to FIGS. 5 and 6, in the hinge structure for a mobile communication terminal that is foldable in two opposite directions according to the invention, the upper hinge portion includes right and left first upper joints 41 that are rotatably connected directly to the central joint 40, right and left second upper joints 42 that are rotatably connected to the first upper joints 41, and upper panels 10 that are rotatably connected to the second upper joints 42, in which these elements are arranged along the central joint 40.

Right and left upper sliders 12 are rotatably connected to rotational bars 44 configured to be rotatable about the central joint 40.

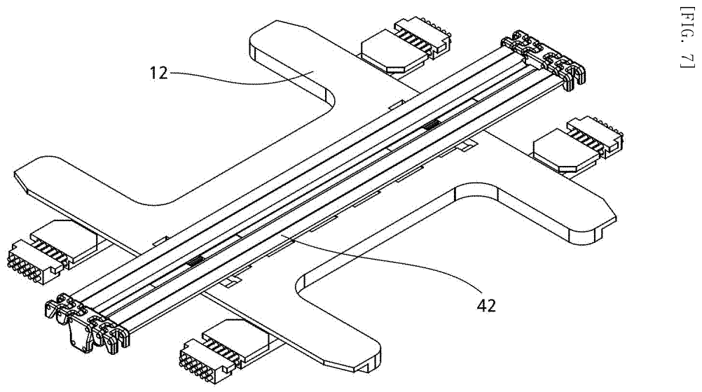

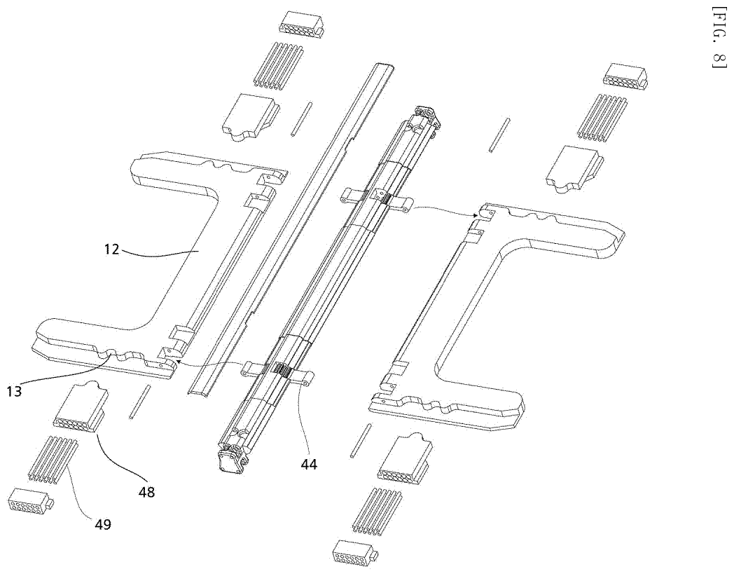

FIG. 7 is a perspective view illustrating a state in which the upper joints and the upper sliders are coupled to the central joint in the upper hinge portion of the hinge structure for a mobile communication terminal that is foldable in two opposite directions according to the invention. FIG. 8 is an exploded perspective view illustrating a state in which the upper sliders are coupled to the central joint according to the invention.

Referring to FIGS. 7 and 8, in the hinge structure for a mobile communication terminal that is foldable in two opposite directions according to the invention, tilt grooves 13 are formed on end faces of the upper sliders 12 connected to the central joint 40.

The tilt groove 13 formed on each end face of each upper slider 12 is connected to an elastically driving member 48 and is supplied with an elastic force from the elastically driving member 48. A coil spring is fitted to shafts 49 constituting the elastically driving member 48 such that an elastic force is applied to the elastically driving member 48 and a protruding tip portion of the elastically driving member 48 is hooked to the tilt groove 13.

The rotational bars 44 which are provided as pairs in the central joint 40 are configured to rotate simultaneously in two opposite directions.

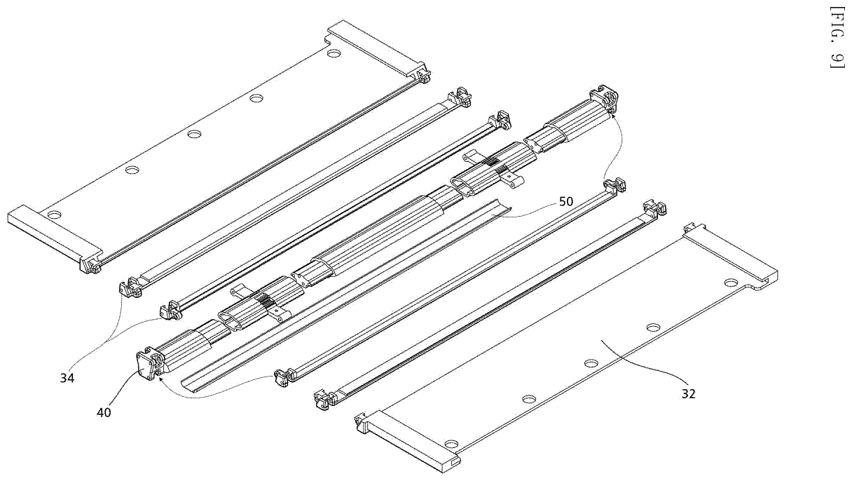

FIG. 9 is an exploded perspective view of the central joint and lower joints and lower sliders which are connected to the bottom of the central joint in the hinge structure for a mobile communication terminal that is foldable in two opposite directions according to the invention.

Referring to FIG. 9, two lower joints 34 are rotatably connected to the right and left sides of the bottom of the central joint 40, and the second lower joint 34 is rotatably connected to the corresponding lower slider 32.

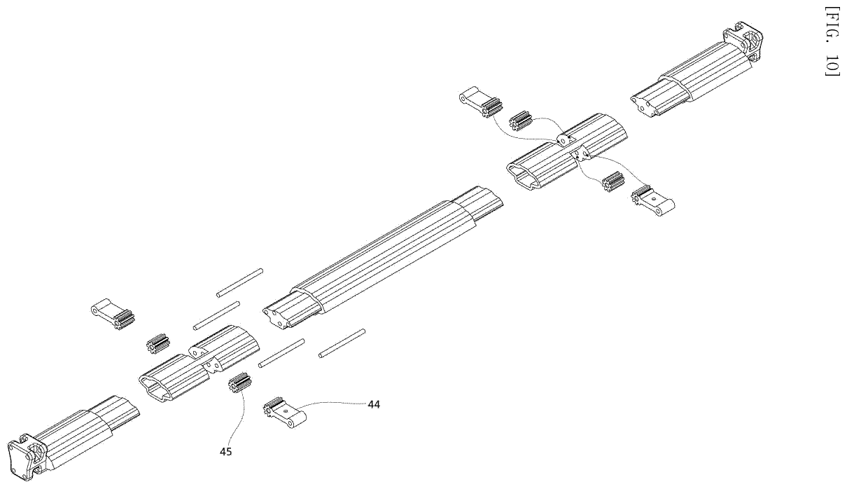

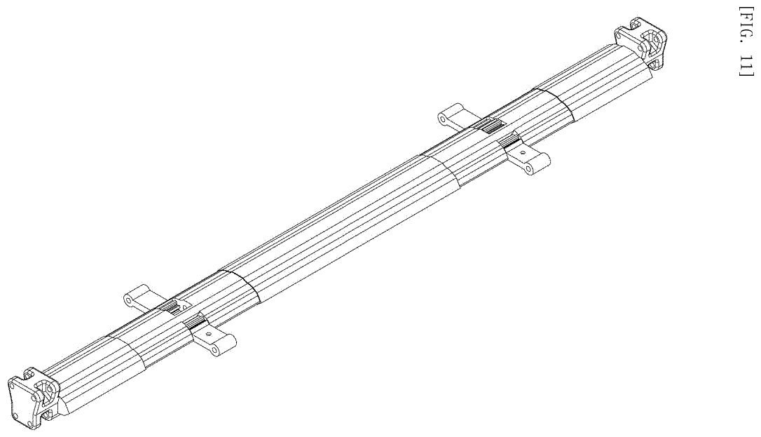

FIG. 10 is an exploded perspective view of the central joint according to the invention. FIG. 11 is a perspective view of the assembled central joint according to the invention.

Referring to FIGS. 10 and 11, the central joint 40 includes a four-axis gear in which a pair of rotational bars 44 and two gears 45 engaging with the rotational bars 44 are coupled to each other

A pair of rotational bars 44 engaging with each other is configured to rotate simultaneously in the opposite directions.

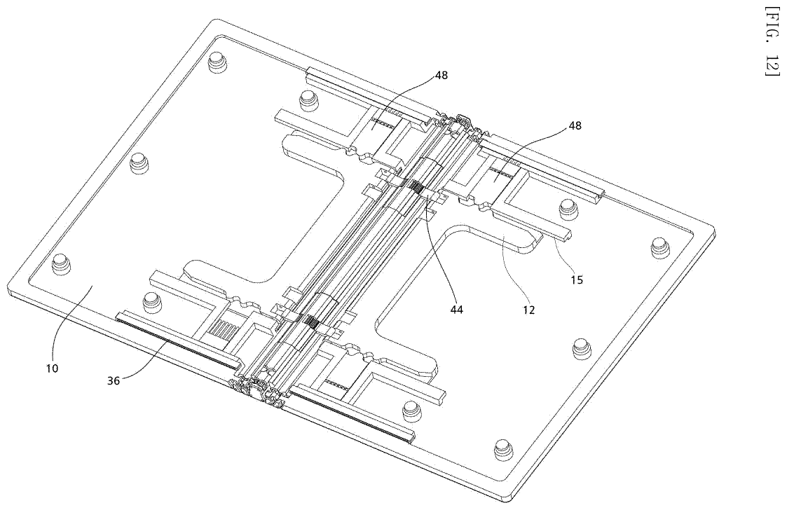

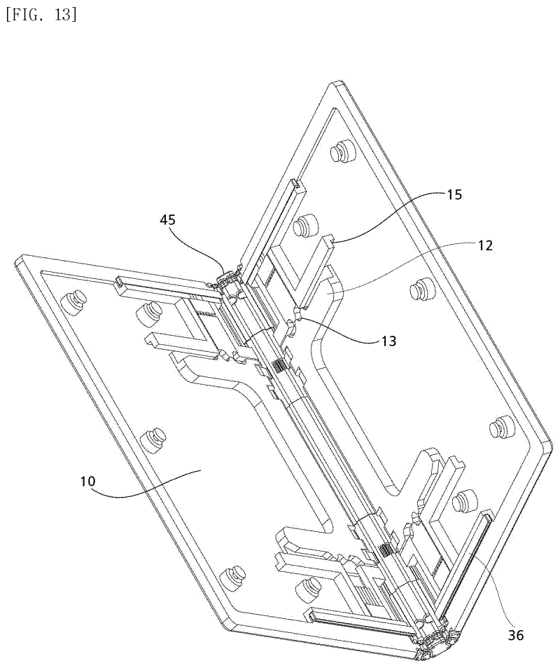

FIG. 12 is a perspective view illustrating the inside of the upper hinge portion of the hinge structure for a mobile communication terminal that is foldable in two opposite directions according to the invention. FIG. 13 is a perspective view illustrating a state in which the upper hinge portion illustrated in FIG. 12 is partially folded.

Referring to FIGS. 12 and 13, a pair of upper panels 10 is connected to each other with the central joint 40 interposed therebetween. The upper sliders 12 that are rotatably connected to the central joint via the rotational bars 44 and the elastically driving members 48 that apply an elastic force to the tilt grooves 13 formed on the end faces of the upper sliders 12 are provided in the pair of upper panels 10 connected to each other.

According to the invention, the upper sliders 12 slide along guide rails 15.

The lower sliders 32 of the lower hinge portion according to the invention are configured to slide along guide rails 36 that are provided in the upper panels 10 in a state in which the lower hinge portion is coupled to the upper hinge portion.

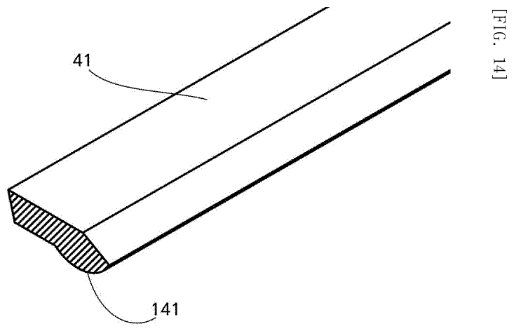

FIG. 14 is a perspective view illustrating a state in which a first upper joint connected to the top of the central joint according to the invention is cut.

Referring to FIG. 14, a support portion 141 is formed in a lower part of each of the first lower joints 41 connected to the right and left sides of the top of the central joint 40. The support portion 141 is configured to come into contact with the surface of the central joint 40 in a state in which the upper panels 10 are fully unfolded such that the first upper joint 41 is prevented from being separated from the surface of the central joint 40.

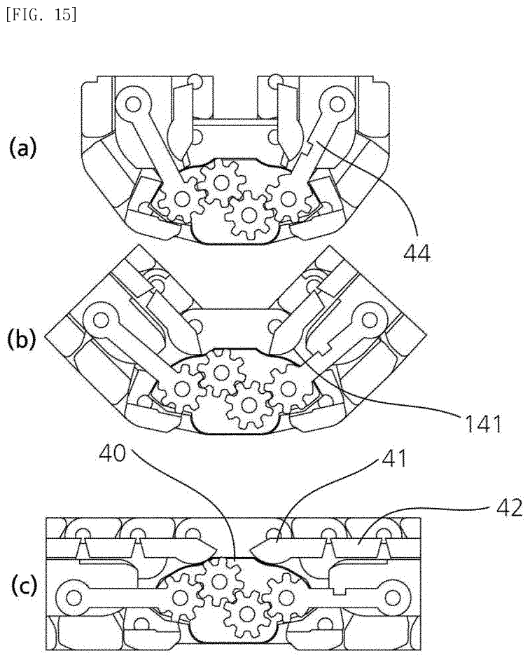

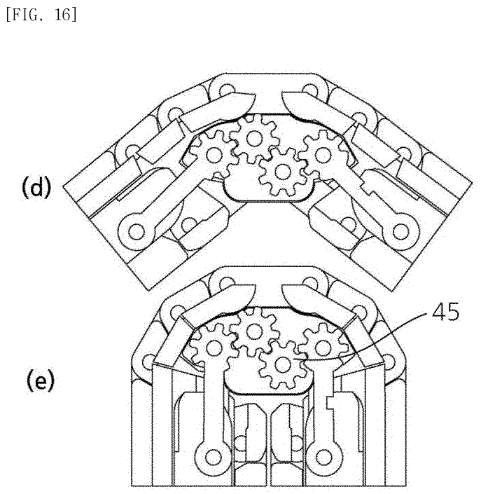

FIG. 15 is a sectional view illustrating movement of rotational bars and gears on the right and left sides of the central joint while the hinge structure for a mobile communication terminal that is foldable in two opposite directions according to the invention is being unfolded in a folded state in an in-folding manner. FIG. 16 is a sectional view illustrating movement of rotational bars and gears on the right and left sides of the central joint while the hinge structure for a mobile communication terminal that is foldable in two opposite directions according to the invention is being folded in a folded state in an out-folding manner.

Referring to FIGS. 15 and 16, while the upper panels 10 and the lower panels 30 coupled to the upper panels 10 are being simultaneously unfolded to a fully unfolded state in a state in which a pair of upper panels 10 according to the invention is folded such that a flexible display panel 50 is invisibly disposed inside, the gears 45 and the rotational bars 44 move in an engaging state.

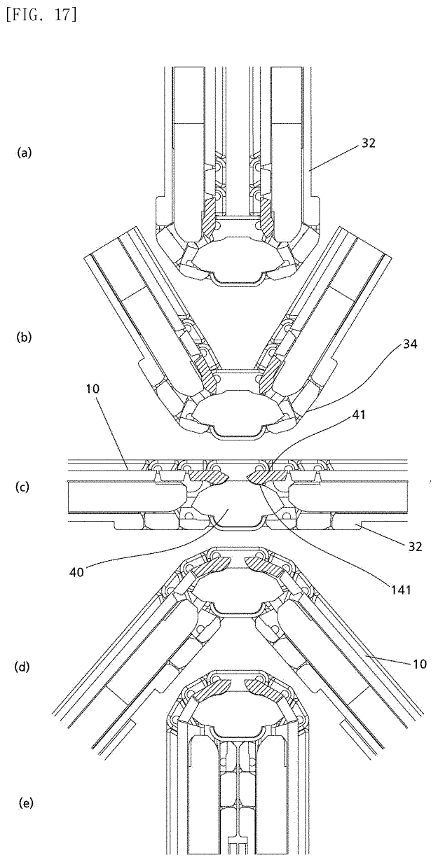

FIG. 17 is a sectional view illustrating a state in which support portions of the first upper joints and the top surface of the central joint come into contact with each other while the hinge structure for a mobile communication terminal that is foldable in two opposite directions according to the invention is unfolding in the folded state in the in-folding manner and being folded in the out-folding manner.

Referring to FIG. 17, the support portions 141 of the first upper joints 41 come into contact with the surface of the central joint 40 in the state in which the upper panels 10 and the lower panels 30 coupled to the upper panels 10 are fully unfolded (c).

Parts of the flexible display panel attached onto the first upper joints 41 are prevented from being recessed inward when the parts are pressed by a user. Accordingly, it is possible to prevent the parts of the flexible display panel from being damaged.

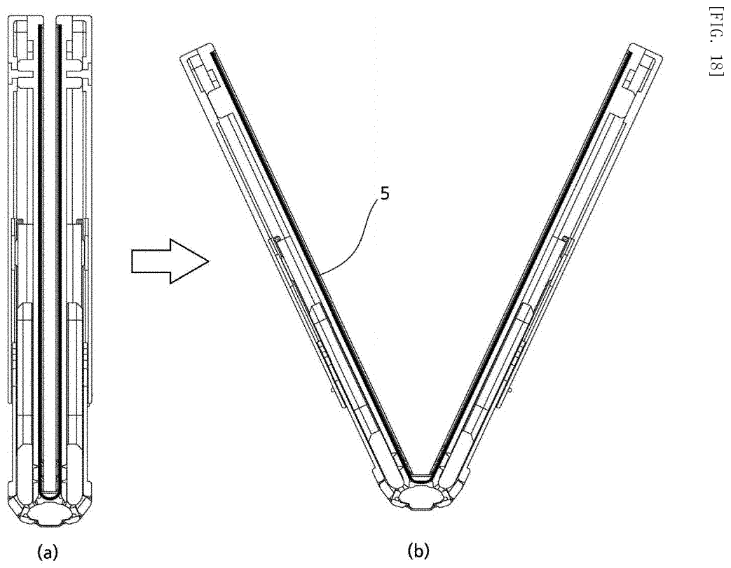

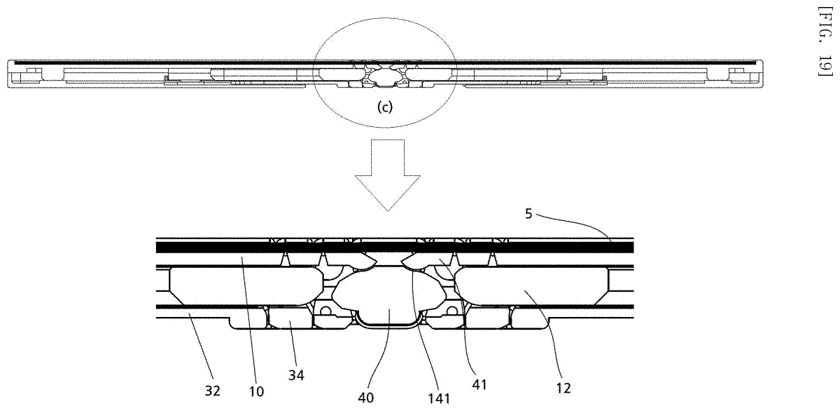

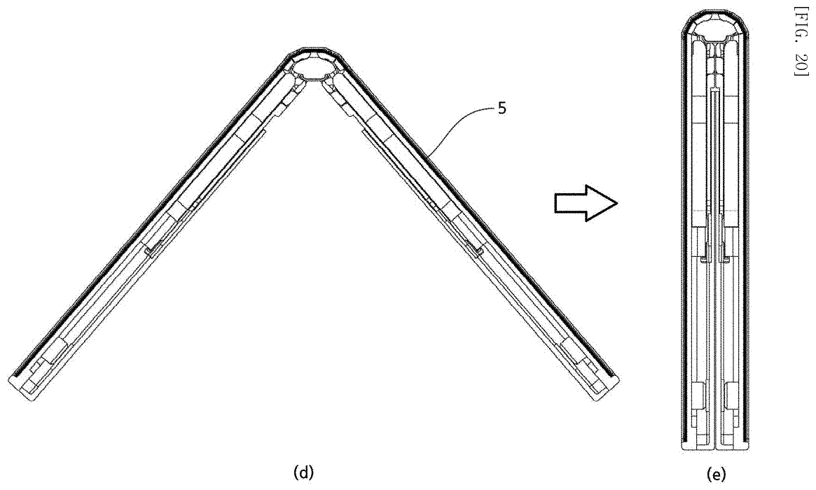

FIG. 18 is a sectional view illustrating movement of internal elements while the hinge structure for a mobile communication terminal that is foldable in two opposite directions according to the invention is being unfolded in the folded state in the in-folding manner in a state in which a flexible display panel is installed on the upper panels of the hinge structure. FIG. 19 is a sectional view illustrating arrangement of the elements in a state in which the hinge structure for a mobile communication terminal that is foldable in two opposite directions according to the invention is fully unfolded in the state in which a flexible display panel is installed on the upper panels of the hinge structure. FIG. 20 is a sectional view illustrating movement of internal elements while the hinge structure for a mobile communication terminal that is foldable in two opposite directions according to the invention is being folded in the out-folding manner.

Referring to FIGS. 18 to 20, the in-folded state illustrated in (a) of FIG. 18 in which the flexible display panel 5 installed in the upper panels 10 is folded is changed to the state illustrated in (b) of FIG. 18 in which the flexible display panel 5 is partially unfolded, and the support portions 141 of the first upper joints 41 come into contact with the surface of the central joint 40 in the state illustrated in (c) of FIG. 19 in which the upper panels 10 and the lower panels 30 coupled to the upper panels 10 are fully unfolded.

When the upper panels 10 and the lower panels 30 coupled to the upper panels 10 are folded in the opposite directions to the state illustrated in (e) of FIG. 20 via the state illustrated in (d) of FIG. 20, a so-called out-folded state in which the flexible display panel 5 is disposed outside is achieved.

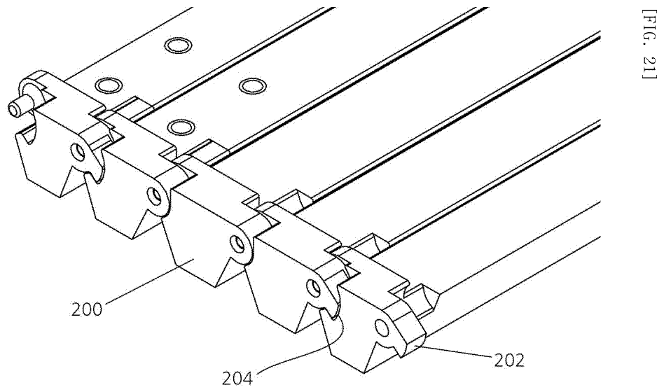

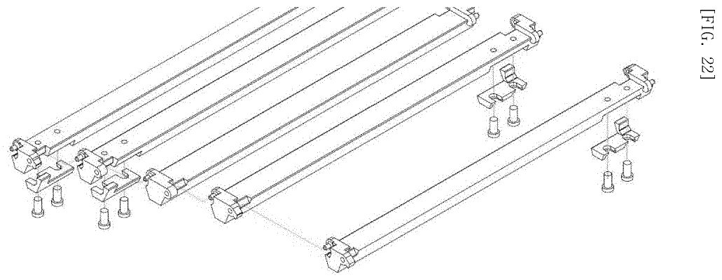

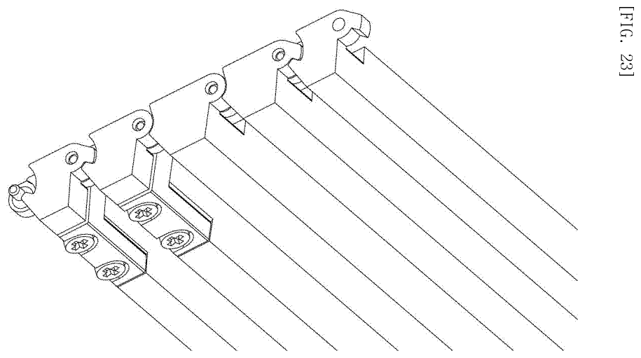

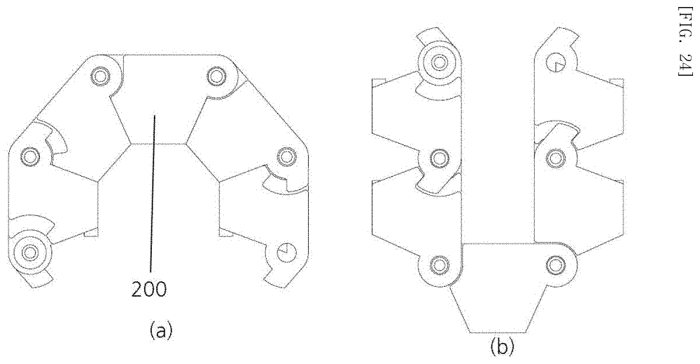

FIG. 21 is a perspective view of a joint structure in which movement of two joints on the right and left sides of the central joint is limited. FIG. 22 is an exploded perspective view of the joint structure illustrated in FIG. 21. FIG. 23 is a perspective view of the joint structure illustrated in FIG. 21 from the bottom side. FIG. 24 is an end view of the joint structure when it is folded in two opposite directions about the central joint.

Referring to FIGS. 21 to 24, stoppers 202 and stopper grooves 204 are provided such that movement of the joints connected on the right and left sides of the central joint 300 is limited.

The folding range is limited in different manners depending on the combination of the stoppers 202 and the stopper grooves 204 between the state illustrated in (a) of FIG. 24 in which the hinge structure is folded downward with respect to the central joint 200 and the state illustrated in (b) of FIG. 24 in which the hinge structure is folded upward with respect to the central joint 200.

While an exemplary embodiment of the invention has been described above using specific terms, such description is only for explanation and it is obvious that the embodiment can be modified in various forms without departing from the technical spirit and scope of the appended claims. Such modified embodiments should not be understood separately from the spirit and scope of the invention and should belong to the appended claims.

1. A hinge structure for a mobile communication terminal that is foldable in both directions, the hinge structure comprising:
upper panels (10) and lower panels (30) that are provided on right and left sides of a central joint (40) and that are foldable inward and outward with respect to the central joint (40);
upper joints (41, 42) that are provided on the right and left sides of a top of the central joint (40) and that are connected to the upper panels (10) and connected to each other; and
lower joints (34) that are provided on the right and left sides of a bottom of the central joint (40) and that are connected to lower sliders (32).

2. The hinge structure for a mobile communication terminal that is foldable in both directions according to claim 1, further comprising upper hinge portions and lower hinge portions that are connected to each other with the central joint (40) interposed therebetween,
wherein the upper hinge portions are connected to the two upper joints (41, 42) via which the right and left upper panels (10) are rotatably connected to the top of the central joint (40),
wherein the lower hinge portions are connected to the two lower joints (34) via which the right and left lower sliders (32) are rotatably connected to the bottom of the central joint (40), and
wherein the right and left lower sliders (32) are inserted into the right and left lower panels (30) and the right and left panels (30) are coupled to the right and left upper panels (10).

3. The hinge structure for a mobile communication terminal that is foldable in both directions according to claim 1, wherein tilt grooves (13) are formed in end faces of right and left upper sliders (12) connected to the central joint (40),
wherein the tilt grooves (13) formed on the end face of each upper slider (12) are connected to an elastically driven member (48) such that an elastic force is applied to the tilt grooves from the elastically driven member (48), and
wherein a protruding tip portion of the elastically driven member (48) is hooked to the tilt grooves (13).

4. The hinge structure for a mobile communication terminal that is foldable in both directions according to claim 1, wherein the central joint (40) includes a four-axis gear in which a pair of rotational bars (44) and two gears (45) engaging with the rotational bars (44) are coupled to each other, and
wherein the pair of rotational bars (44) engaging with each other is configured to rotate simultaneously in opposite directions.

5. The hinge structure for a mobile communication terminal that is foldable in both directions according to claim 1, wherein a support portion (141) of each first upper joint (41) is provided come into contact with a surface of the central joint (40) in a state in which the upper panels (10) and the lower panels (30) coupled to the upper panels (10) are fully unfolded.
